(19) United States
(12) Patent Application Publication
(10) Pub. No.: US 2019/0366992 A1
(43) Pub. Date: Dec. 5, 2019

(54) Interface Element for a Vehicle

(71) Applicant: KNORR-BREMSE Systeme fuer Nutzfahrzeuge GmbH, Muenchen (DE)

(72) Inventors: Andre KLUFTINGER, Kleinheubach (DE); Martin MEDERER, Neumarkt (DE); Andreas LEINUNG, Muenchen (DE); Felix THIERFELDER, Unterschleissheim (DE)

(21) Appl. No.: 16/529,232

(22) Filed: Aug. 1, 2019

Related U.S. Application Data
(63) Continuation of application No. PCT/EP2018/052230, filed on Jan. 30, 2018.

(30) Foreign Application Priority Data
Feb. 2, 2017 (DE) 10 2017 102 074.8

(51) Int. Cl. B60T 8/17; B60T 8/88; B60R 16/033

(52) U.S. Cl. CPC B60T 8/1708; B60R 16/033; B60T 8/885; B60T 8/1705

(57) ABSTRACT

An interface element for a vehicle has electronic components, wherein the electronic components have at least one connection to at least one data interface of the vehicle. The connection is suitable and created for exchanging measurement data and/or open-loop and/or closed-loop control data for controlling electronic components. The electronic components also have at least one integrated measurement and/or open-loop and/or closed-loop control unit.

### CROSS REFERENCE TO RELATED APPLICATIONS

This application is a continuation of PCT International Application No. PCT/EP2018/052230, filed Jan. 30, 2018, which claims priority under 35 U.S.C. § 119 from German Patent Application No. 10 2017 102 074.8, filed Feb. 2, 2017, the entire disclosures of which are herein expressly incorporated by reference.

### BACKGROUND AND SUMMARY OF THE INVENTION

The invention relates to an interface element for a vehicle, in particular for a utility vehicle or rail vehicle, having electronic components, to a vehicle, in particular a utility vehicle or rail vehicle, having at least one such interface element, and to a method for the at least partial measurement and/or open-loop and/or closed-loop control and/or monitoring of a utility vehicle.

It is already known from the prior art to provide, in vehicles, in particular utility vehicles, central open-loop control and closed-loop control and monitoring of the driving state of the utility vehicle, or to combine the intelligent evaluations into a small number of larger control units. However, this generally has the result that the vehicle electronics and the open-loop control and/or closed-loop control are set to the status quo at the time of the development of the utility vehicle. Utility vehicles however have a relatively long service life.

WO 2002/33790 A1 has already disclosed a plug connection in the case of which an electronic plug connection is integrated into the end of an optical waveguide together with an optoelectronic signal transducer.

DE 10 2007 043 887 A1 has furthermore already disclosed a plug connector with integrated electronics. Here, an electronic circuit board is provided in the plug connector casing.

A further example for a plug connector with integrated electronics is DE 10 2005 060 798 A1, which has a plug connector with integrated electronics for electromagnetic signal transmission, and contacts for power transmission.

The above examples do not originate from the utility vehicle sector or rail vehicle sector.

It is the object of the present invention to further develop a plug-in element, a utility vehicle and a method for the open-loop control and/or closed-loop control of a utility vehicle in an advantageous manner, in particular such that electronic systems for a utility vehicle can be easily retrofitted, redundancies in the open-loop control and/or closed-loop control in a utility vehicle can be easily added, and the open-loop control and/or closed-loop control of a utility vehicle can be improved overall.

This and other objects are achieved by way of an interface element for a utility vehicle in accordance with the claimed invention.

According to the invention, provision is made whereby an interface element for a vehicle comprises electronic components, wherein the electronic components have at least one connection to at least one data interface of a vehicle, wherein the connection is suitable and created for the exchange of measurement data and/or open-loop and/or closed-loop control data for the measurement of operationally relevant data and/or open-loop and/or closed-loop control of electronic components, wherein the electronic components furthermore have at least one integrated measurement and/or open-loop control and/or closed-loop control unit.

The vehicle may for example be a utility vehicle such as a heavy goods vehicle or a rail vehicle.

The invention is based on the underlying concept that, irrespective of the location of the central open-loop control and/or closed-loop control and of the associated signal lines and components of a utility vehicle, it is additionally possible, by use of an additional, intelligent interface element, to attach decentralized open-loop control and/or closed-loop control electronics at virtually any desired location in the utility vehicle. The open-loop control and/or closed-loop control electronics can perform additional open-loop control and/or closed-loop control tasks independently of the main open-loop control and/or closed-loop control of the utility vehicle. Furthermore, the interface element is capable of receiving but also correspondingly transmitting measurement data. Processing of measurement data is also possible. On the basis of this, the open-loop control and/or closed-loop control can then be performed.

Open-loop control and/or closed-loop control intelligence is thus integrated into an interface element for a utility vehicle, wherein said interface element can be attached in an independently positioned manner at any desired location on the utility vehicle.

It is however possible in particular for sensors and/or actuators not to be integrated into the interface element.

The interface element may thus have no sensor.

Furthermore, the interface element may have no actuator.

A simple construction of the interface element is made possible in this way.

It is furthermore contemplated that the interface element has activation elements such as output stages or the like, by which, for example, the electrical control signal required for an actuator can be generated.

It is however also contemplated for the data interface to comprise in each case one unidirectional data interface, which permits a transmission of data in one but also in the other direction. Through the integration of intelligent electronics into a plug-in element, it is possible for further open-loop control and closed-loop control electronics to be added to the utility vehicle independently of structural space available in the vehicle or the structural space available in the context of the central vehicle open-loop control and closed-loop control. The structural space is provided de facto by the casing of the interface element and/or the cable of the interface element. Retrofitting of open-loop control and/or closed-loop control components for the utility vehicle is thus easily and inexpensively possible. The construction of redundant systems is also facilitated in this way. This is because, by means of the interface element, it is made possible for additional electronics to be added at suitable locations, and for redundant systems to be constructed.

It is in particular also contemplated for an intelligent interface element network to be formed from multiple networked interface elements. By means of such an interface element network, it is possible in this respect, or in the context of the corresponding functional subsystem, for a complete omission of further control units to be realized or made possible. The interface elements that form the interface element network thus need not imperatively be connected to the central control unit of the vehicle.

Provision may furthermore be made whereby the integrated open-loop control and/or closed-loop control unit is a microcontroller or comprises a microcontroller. Through the use of a microcontroller, it is easy to form an integrated open-loop control and/or closed-loop control unit.

The integrated measurement and/or open-loop control and/or closed-loop control unit may furthermore comprise a processor and/or an integrated circuit and/or at least one data interface. The exchange of data with other components of the vehicle is thus made possible. It is furthermore also achieved in this way that data can be received, processed and transmitted onward.

The interface element may be designed as a plug-in element. Simple installation is made possible in this way. The retrofitting of the interface element into vehicles that are already operational is thus facilitated. It is contemplated that standardized plug-in sockets conforming to a suitable industrial standard are selected as a plug-in facility.

It is also contemplated for the interface element to be formed in a cable or as a cable element, in particular connecting cable. This design possibility likewise facilitates the retrofitting of vehicles that are already operational. Decentralized intelligent, additional networks composed of multiple interface elements can be established in this way.

The electronic components may be of water-tight protected form. In particular, it is contemplated that the interface element, in the installed state, seals off its electronic components in water-tight fashion. In other words, provision may be made whereby the electronic components are of water-tight protected form. A robust configuration of the interface element is thus made possible. An arrangement of the interface element at virtually any desired location in the utility vehicle with virtually any desired environmental requirements is thus made possible. These also include locations on the utility vehicle which are fastened for example in the vicinity of the tires or below the driver's cab or in conjunction with the superstructures of the utility vehicle.

It is furthermore possible for the interface element to be connectable or connected to a sensor.

Provision may be made in particular for the sensor to be a wheel rotational speed sensor.

The interface element may be connected to at least one sensor. By means of this intelligent sensor evaluation, it is possible for particular values that monitor the driving behavior of the vehicle or describe operating states of the vehicle to be processed further or checked for plausibility. Contemplated in this context are in particular evaluations of acceleration sensors, temperature sensors, vibration sensors, pressure sensors, wheel rotational speed sensors or the like.

The interface element is connectable or connected to an actuator.

The actuator may for example involve activation elements for valves or actuation elements or switching elements of any type or the like.

It is thus possible for reading-in of setpoint values via a data interface or an outputting of input values via a data interface of the interface element to be made possible. It is also possible for actuators to be activated via at least one digital or analog output of the interface element. A reading-in of measurement values via such an analog or digital input is also contemplated.

One possible application of the interface element, if connected to a sensor, could be one in which only (for example analog) measurement signals are evaluated by means of the interface element and these are input in a standardized data format into a data bus, such that all control units, that is to say for example also two redundancy-safeguarding control units, can simultaneously access this single measurement signal in the data format with little additional outlay, by virtue of the fact that the two control units merely have to be connected in inexpensive fashion to the same data bus. One example would be the detection of the wheel rotational speed signals, which could be performed in the interface element. At the same time, the interface element could likewise monitor these signals for errors and input detected errors, by means of special values of the digital measurement signal, into the data bus for any desired number of control units. Thus, the measurement signal is, by means of the interface element alone, transformed for all connected control units into a duplicated, safeguarded measurement signal which, without outlay in terms of the central control units, can be identified by these as a valid or implausible measurement value simply by means of the data value.

As a smallest contemplated unit composed of the simplest interface elements, this would be the simple coupling of two interface elements at their data interface, wherein one interface element reads out a sensor and the other activates an actuator. The two interface elements could exchange the closed-loop control variables with one another via the data interface, and, in a closed-loop control circuit, read in the measurement values on one side of the assembly and activate actuators on the other side.

The connection to the at least one data interface of a vehicle may be a wired connection or comprise a wired connection.

The connection may also be a radio connection or comprise a radio connection.

Provision may furthermore be made whereby the connection is an optical connection or comprises an optical connection.

It is furthermore contemplated for the connection to be a magnetic connection or to comprise a magnetic connection.

The interface element may be connectable or connected to an external power supply source.

Alternatively or in addition, provision may be made whereby the interface element is connectable or connected to an internal power supply source, wherein, in particular, the internal power supply source is or comprises a battery.

The interface element can thus be supplied with electrical energy by means of another voltage source or by means of an integrated battery. For this purpose, a deactivation facility may be provided in the interface element with regard to energy saving.

It is contemplated that, under certain boundary conditions, overvoltage protection can be omitted in the interface element, and the interface element thus has no overvoltage protection.

It is to be noted that electronic components in the automotive sector must generally be safeguarded against overvoltage in order that they cannot be destroyed. Such voltage peaks may originate for example from the switching processes of the alternator. If the interface element is supplied directly from the alternator/battery of the vehicle, integrated overvoltage protection would presumably be necessary. This can however be omitted if the interface element were supplied with current via a, or multiple redundant, control unit(s), which already absorb an overvoltage by means of a dedicated protection device. The interface element would thus be jointly safeguarded owing to the protective devices of the one or more external control units and of the associated voltage source that provides voltage to the respective control unit.

The open-loop control and/or closed-loop control unit integrated in the interface element may for example have software or an algorithm for the closed-loop control of an actuator or for the processing of a sensor signal. In particular, it is contemplated for software to be provided for the detection of a rotational speed, in particular of a wheel rotational speed or of the rotational speeds thereof of the utility vehicle. In this context, consideration must also be given to acceleration sensors, for example in order to be able to compare the wheel rotational speed with the accelerations acting on the acceleration sensor.

The interface element may serve as a gateway between two data bus interfaces.

It is however also contemplated for the interface element to be utilized as a closed-loop controller, for example as a cascaded reference-variable closed-loop controller, which activates the actuator in a manner dependent on a setpoint value from the data bus.

In this context, it is also contemplated for the interface element to be integrated into existing vehicle structures, for example in order to also be able to perform a cable exchange.

Provision may also be made whereby the interface element with its open-loop control and/or closed-loop control unit has a memory unit, such that it is for example also possible for data to be input. In this case, it would be possible for the open-loop control and/or closed-loop control unit to be designed as a datalogger or as a black-box plug. Functions such as lookup tables and/or data conversion may likewise be provided.

Single-channel or else multi-channel processing of sensors or an activation of actuators may be performed.

It is also contemplated to realize a casing in half-shell form with a sealing filling for realizing the water tightness. It is also contemplated for the water tightness to be realized through complete or partial potting of the elements of the interface element. Full encapsulation of the plug, or a single-piece form of the plug, is alternatively also contemplated. It is also contemplated for the electronic components to be enclosed in water-tight fashion by means of a cable which is sealed at the ends.

In particular, the interface element may be used to realize an activation of valves of the ABS system of the utility vehicle, of the electronic brake system of the utility vehicle, of the air suspension system of the utility vehicle or of an air treatment system of the utility vehicle or of a compressed-air supply system of the utility vehicle. It is also contemplated for such interface elements to be used in conjunction with the brake system of the utility vehicle.

A redundant supply may be provided to the interface element by means of at least two voltage supplies. It is contemplated for the interface element to have an integrated power store. For the supply of power, it is furthermore alternatively and/or additionally possible for a connection to the power supply system of the utility vehicle to be realized.

The connection to the data interface of the utility vehicle may be a wired connection or comprise a wired connection. It is however also contemplated for the connection to the data interface of the utility vehicle to be a radio connection or to comprise a radio connection.

Provision may basically be made for a wired or wireless data interface to be provided and established.

Provision may furthermore be made for the interface element to be connectable to the electrical supply network of the utility vehicle and/or to be, in the installed state, connected to the electrical supply network of the utility vehicle.

Provision may furthermore be made for the interface element to have an interface to a mobile terminal, in particular to a smartphone and/or to a Tablet PC. A remote maintenance functionality can for example be established in this way.

It is also contemplated that the vehicle can be monitored online, and thus the driving state and operating state of the utility vehicle can be continuously remotely monitored.

Provision may furthermore be made whereby online fault monitoring of the operating systems of the utility vehicle can be performed.

By means of the above-described optional datalogger function, it is also contemplated for the data obtained online to simultaneously also be recorded.

It is thus possible that the interface element permits and forms a datalogger function with simultaneous online monitoring.

The interface element and its electronic components may have an encrypted communication protocol. By means of the encrypted communication protocol, it is possible to achieve safeguarding against hacking and unauthorized data leakage or hostile remote takeover of the control systems of the utility vehicle.

The interface element may furthermore have an evaluation unit by means of which measurement signals can be evaluated, in particular measurement signals of the at least one sensor arranged in the plug-in element can be automatically evaluated, in the interface element.

Provision may furthermore be made whereby the interface element has a monitoring unit by means of which continuously received measurement signals can be automatically monitored for the purposes of monitoring the operating state of the utility vehicle.

Provision may also be made whereby the interface element has a signal comparison unit by means of which open-loop control and/or closed-loop control signals in the interface element and in the utility vehicle can be compared.

The invention furthermore relates to a vehicle, in particular utility vehicle or rail vehicle, having at least one interface element as described above.

The present invention furthermore relates to a method for the at least partial measurement and/or open-loop control and/or closed-loop control and/or monitoring of a vehicle, in particular of a utility vehicle or rail vehicle, wherein the at least partial measurement and/or open-loop control and/or closed-loop control and/or monitoring of the utility vehicle is performed not by central control units in the vehicle architecture but in decentralized fashion by at least one interface element, in particular an interface element according to the invention.

In particular, in the context of the method, the interface element may be used to provide an activation of valves of the ABS system of the utility vehicle, of the electronic brake system of the utility vehicle, of the air suspension system of the utility vehicle or of an air treatment system of the utility vehicle or of a compressed-air supply system of the utility vehicle.

Additional open-loop control and/or closed-loop control in relation to the existing open-loop control and/or closed-loop control systems and components of the utility vehicle can be performed by means of the interface element.

It is also contemplated, in the context of the method, for such interface elements to be used in conjunction with the brake system of the utility vehicle.

A redundant supply may be provided to the interface element by means of at least two voltage supplies.

It is contemplated for the supply of power to the interface element to be realized in autonomous form and not via the central power supply of the utility vehicle. For this purpose, the interface element may have an integrated power store.

It is however also contemplated that, for the supply of power, a connection to the power supply system of the utility vehicle is alternatively and/or additionally realized.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a brake system having an air treatment unit and having an exemplary embodiment according to the invention of a plug-in element for a utility vehicle according to the invention for carrying out an exemplary embodiment according to the invention of a method for the partial open-loop control and/or closed-loop control and/or monitoring of a utility vehicle.

FIG. 2 shows a first exemplary embodiment of a plug-in element according to the invention.

FIG. 3 shows a second exemplary embodiment of a plug-in element according to the invention.

FIG. 4 shows an example of a possible connection of the plug-in element to the vehicle architecture of the utility vehicle.

### DETAILED DESCRIPTION OF THE DRAWINGS

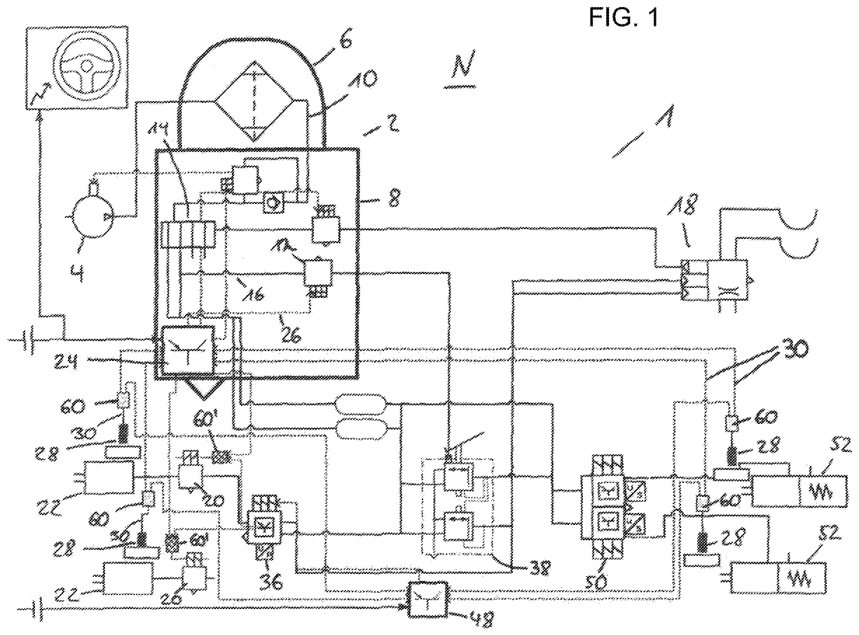

FIG. 1 is a schematic illustration of a brake system 1 for a utility vehicle, having an air treatment unit 2 and having an exemplary embodiment according to the invention of an interface element 60 and 60′ for a utility vehicle N for carrying out an exemplary embodiment of a method for the partial open-loop control and/or closed-loop control and/or monitoring of the utility vehicle N. The interface element may be in the form of a plug-in element.

It is basically possible for the plug-in elements 60 and 60′ to be used, not only in conjunction with the exemplary embodiment shown in FIG. 1, in conjunction with a brake system and air treatment unit of the utility vehicle. Use in conjunction with all electronic systems of the utility vehicle N is possible.

The air treatment unit 2 comprises a filter cartridge 6 which is connected to a compressor 4 and which serves for filtering and drying the compressed air provided by the compressor 4.

The filter cartridge 6 is arranged on a casing 8 of the air treatment unit 2 and is pneumatically connected to the casing 8 via a filter cartridge line 10.

A charging valve 12 is arranged in the casing 8.

In this exemplary embodiment, the charging valve 12 is connected to the filter cartridge line 10 via a distributor unit 14.

Here, the charging valve 12 is arranged in the connecting line 16. For an advantageous function, the pressure pick-off point may also be arranged upstream of the distributor unit 14.

In one exemplary embodiment, it is important that the supply pressure for the charging valve 12 is stable, that is to say does not fall to zero in the absence of a compressor conveying action.

Thus, in this exemplary embodiment, the pressure pick-off point may also be situated between the distributor unit 14 and the check valve.

In a known manner, the air treatment unit 2 is for example pneumatically coupled to two control valves 20, which are connected upstream of in each case one of two front wheel brake cylinders 22 of a front axle of the utility vehicle.

By means of the air treatment unit 2, a supply is likewise provided to a trailer control module 18.

A control unit 24, which is likewise arranged in the casing 8, is designed to activate the charging valve 12 by outputting a corresponding control signal 26.

The control valves 20 are designed to change a respective brake pressure in the front wheel brake cylinders 22.

The activation of the control valves 20 by means of the air treatment unit 2 is for example performed such that locking of the wheels during braking is prevented, or the utility vehicle is braked on one side.

In this exemplary embodiment, the charging valve 12 is designed to charge the control valve connection 18 with a setpoint pressure which can be output in multiple steps between ambient pressure and operating pressure, wherein, for example, said setpoint pressure can be extracted in part directly from the solenoid valve and in part, with a boosted air flow rate, from a relay valve.

Alternatively, the charging valve 12 may be designed to charge the control valve port 18 with a control pressure for the pneumatic activation of a valve or valve module, connected upstream of the two control valves 20, of the brake system 1, for example a relay valve, as the setpoint pressure.

For example, the utility vehicle is equipped with a total of four optional wheel rotational speed sensors 28 for detecting a rotational speed of in each case one wheel at a front and a rear axle.

The wheel rotational speed sensors 28 transmit in each case one wheel rotational speed signal 30, which represents the respective rotational speed of a wheel, to the control unit 24, wherein the control unit 24 is designed to activate the charging valve 12 using the wheel rotational speed sensor signals 30, that is to say in a manner dependent on the respective rotational speed of the wheels.

Optionally, the control unit 24 uses the wheel rotational speed sensor signals 30 in order, additionally or alternatively to the charging valve 12, to directly electrically activate the two control valves 20, in particular such that, during braking of the utility vehicle, locking of the front wheels is prevented, or the utility vehicle is additionally braked on one side.

By means of the charging valve 12, the brake system 1 can be activated in a known manner.

A parking brake function is likewise realized in a suitable manner, as is known from the prior art.

The two front wheel brake cylinders 22 are connected via a front-axle valve module 36 to a footbrake module 38 of the brake system 1.

The two control valves 20 are arranged between the front wheel brake cylinders 22 and the front-axle valve module 36.

The brake system 1 shown in FIG. 1 can be activated for example by an EBS control unit 48 of an electronic brake system of the utility vehicle.

For this purpose, the EBS control unit 48 is for example connected to the wheel rotational speed sensors 28, to the footbrake module 38 and to the front-axle valve module 36 for the purposes of electrical signal transmission.

In one exemplary embodiment, the control unit 24 of the air treatment unit 2 is designed to activate the charging valve 12 in the event of failure of the electronic brake system such that adequate braking performance at the front axle of the utility vehicle can continue to be ensured.

The footbrake module 38 is furthermore connected via a rear-axle valve module 50 to two rear wheel brake cylinders 52 of the rear axle of the utility vehicle.

Merely by way of example, by contrast to the front axle, no ABS control valves are arranged between the rear-axle valve module 50 and the rear wheel brake cylinders 52.

In this exemplary embodiment, the two rear wheel brake cylinders 52 are designed to lock the rear wheels of the utility vehicle in the ventilated state by means of spring force.

The rear wheel brake cylinders 52 are thus a constituent part of the immobilizing or parking brake function.

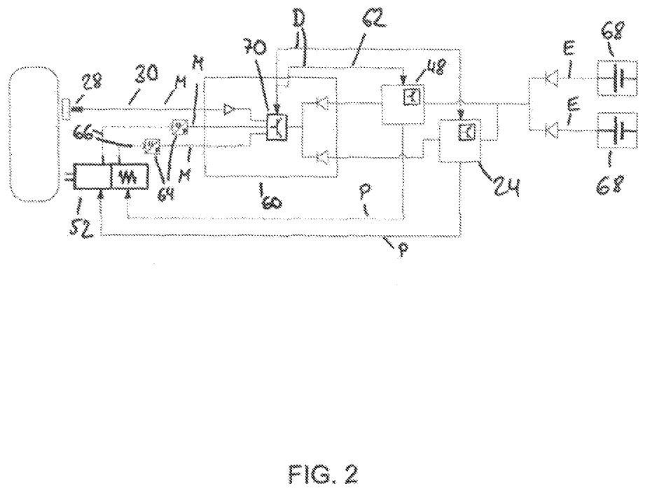

FIG. 2 shows a first exemplary embodiment of an interface element according to the invention in the form of a plug-in element 60.

The plug-in element 60 according to the invention in this embodiment is designed as a plug-in element with integrated sensor function evaluation logic and for connection to sensors, in this case a wheel rotational speed sensor 28 with wheel rotational speed sensor signal 30 and pressure sensors 64.

The plug-in element 60 is connectable by way of a connection 62 directly or indirectly to the EBS control unit 48 as shown in FIG. 1. A connection to the control unit 24 is also provided.

In FIG. 2, electrical lines are denoted by E, data signal lines are denoted by the reference designation D, pneumatic lines are denoted by P, and measurement signal lines are denoted by M.

The plug-in element 60 has two pressure sensors (pressure-voltage transducers) 64 which, by means of corresponding measurement signal lines 66, may be connected to, for example, the rear wheel brake cylinders 52.

Here, too, a corresponding plug-in connection for the measurement lines 66 is contemplated.

It is however also contemplated for the illustrated layout of the interface element 60 to be formed overall as a cable element and not as a plug-in element.

Furthermore, the plug-in element 60 has connections to two batteries 68, by means of which, for example, accelerations or else the wheel rotational speed can be measured.

The plug-in element 60 furthermore has a microcontroller 70.

The microcontroller 70 may have an evaluation unit for realizing an evaluation function, a monitoring unit for realizing a monitoring function, and a signal comparison unit for realizing a signal comparison function.

The electronics of the plug-in element 60 are encapsulated in water-tight fashion, in this case by virtue of the plug-in element 60 being formed as a casing in half-shell form with a gel filling or potting compound for achieving the water-tightness.

Full encapsulation of the plug-in element 60 and of the electronics present in the plug-in element 60 may alternatively be realized.

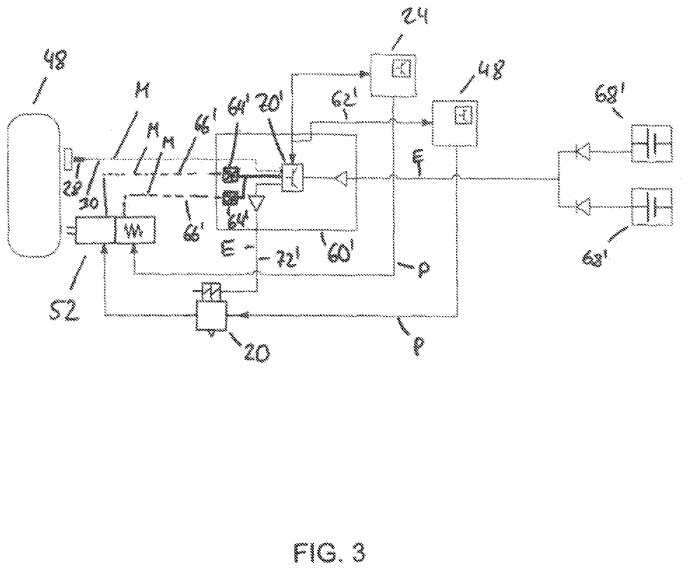

FIG. 3 shows a plug-in element 60′ which is of substantially identical construction and which has all of the structural and functional features and also the plug-in element 60 as per FIG. 2.

Correspondingly identical elements are merely denoted in more detail by means of a primed reference designation or identical reference designation.

The plug-in element 60′ additionally has an actuator function. Here, an electrical control line 72′ is provided, by means of which a solenoid valve, in this case the control valve 20 (see FIG. 1), can be activated.

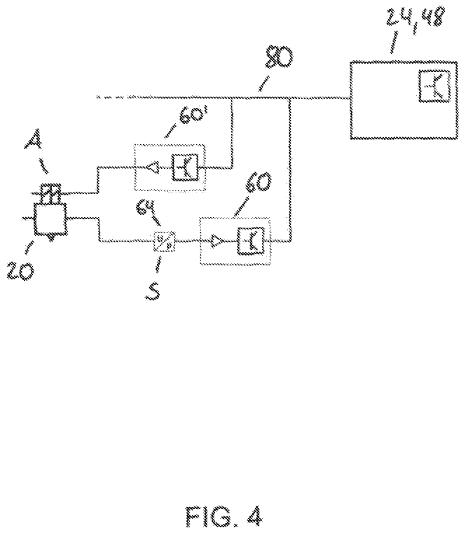

As shown in FIG. 4, it is possible by means of the plug-in element 60 and 60′ for the vehicle architecture of the utility vehicle, as is also represented by way of example in FIG. 1, to be expanded by the brake system 1 of the utility vehicle N. By means of the connection of the plug-in element 60 and 60′ to a data bus 80 of the utility vehicle N, further possibilities for activation of actuators A, represented here by way of example by a control valve 20, or sensor elements S, represented here by way of example by a pressure sensor 64, are made possible.

It is thus also the case, for example with regard to autonomous driving, that an advantageous distribution of functions over the entire utility vehicle N is made possible. A non-redundant rotational speed evaluation of the EBS system in the plug-in element 60 and 60′ is contemplated. In this way, redundant ECU and EAC modularity is also made possible, because access hereto is realized via the plug-in element 60 and 60′.

Standard sensors may be used.

Existing vehicle systems of a utility vehicle N may be expanded (see FIG. 4), for example in order to be able to provide higher-quality sensor information and functions. Here, it is possible in particular for intelligent electronics to be retrofitted in existing vehicle systems.

Space-saving, variable and location-independent fixing of the plug-in element 60 and 60′ may be realized at positions at which structural space is available for integrating control functions and also corresponding hardware and control electronics into the plug-in element 60 and 60′.

A connection to the EBS system 48 or the control unit 24 or other open-loop control and/or closed-loop control systems of the utility vehicle N may be realized either in wired or wireless fashion, for example by radio.

Multiple control outputs may be provided on the plug-in element 60 and 60′. Analogously to a sensing plug-in element 60, it is also possible to provide cascaded closed-loop control, adapted to an actuator A (see FIG. 3).

It is contemplated for the entire signal arrangement to be made available in one-off fashion for all redundant systems connected to the data bus.

By means of the compact design and the low inherent weight of the plug-in element 60 and 60′, resistance to vibrations is also realized.

In the case of additional functions, it is also possible to be able to perform an update without a modification of the connected main unit, in this case for example of the EBS system 48 or EAC system. It is simply merely necessary for the plug-in elements 60 and 60′ to be partially or entirely exchanged or for these to be correspondingly brought into the newest state by means of an update.

It is furthermore contemplated to be able to connect a mobile communication interface, for example by way of WLAN, Bluetooth or other radio protocols. By means of this interface, coupling to mobile terminals is possible, for example to a smartphone or to a Tablet PC and/or also generally to a server in the Internet. Also contemplated is connection to an online monitoring system which is used for remote maintenance, for data recording, remote control or the like.

An additional casing and also a plug connection as a whole are omitted, because there is no need for a separate further central open-loop control and/or closed-loop control unit to be integrated.

Rather, plug-in elements 60 and 60′ are simply integrated into the system at suitable locations.

It is furthermore contemplated for conditioning of sensor signals to be performed, for example a characteristic map adaptation. It is also contemplated to be able to perform a sensor exchange with changed characteristic map without modification of the central control units of the brake system or utility vehicle N.

The plug-in elements 60 and 60′ may have analog outputs. Multiple different sensors with different output signals may be provided in one plug-in element 60 and 60′.

Altogether, this results in a considerable saving of inputs and outputs on the main control unit, for example the EBS system 48 or the EAC system. In the extreme case, it is merely the case that a relocation of data bus connections of control functions and hardware into the plug-in element 60 and 60′ is performed (in this regard, see also FIGS. 2, 3 and 4).

It is possible for multiple control outputs to be provided, which, on the basis of a setpoint value from the data interface, correspondingly activate components of the utility vehicle N, see FIG. 3, in this case activation via the line 72 of the control valve 20.

Cascaded closed-loop control may be provided in a manner adapted to the actuator.

Even without modification of the central control units, it would be possible for a utility vehicle N and its control system to be adapted to a new actuator by means of changed demands and functions in the plug-in element 60 and 60′.

This may for example even be realized merely through corresponding software modification of the plug-in element.

Here, a corresponding software update would be possible via the microcontroller 70 and corresponding memory means in the plug-in element 60 and 60′.

By means of the plug-in element 60 and 60′ and the intelligent electronics present therein, it is also basically possible to monitor the sensor signals in the entire utility vehicle N and in this way be able, for example, to identify cable breakages or other system faults and hereby realize a failsafe principle or a state of said type.

Tap-proof communication of the sensor signal is also possible by means of encrypted transmission via the data bus 80.

One possible application of interface elements 60, 60′ may be realized, analogously to the exemplary embodiment according to FIG. 4, in that only (for example analog) measurement signals are evaluated by means of the interface element 60 and these are input in a standardized data format into a data bus 80, such that all control units, that is to say for example also two redundancy-safeguarding control units, can simultaneously access this single measurement signal in the data format with little additional outlay, by virtue of the fact that the two control units merely have to be connected in inexpensive fashion to the same data bus. One example would be the detection of the wheel rotational speed signals, which could be performed in the interface element 60. At the same time, the interface element could likewise monitor these signals for errors and input detected errors, by means of special values of the digital measurement signal, into the data bus 80 for any desired number of control units. Thus, the measurement signal is, by means of the interface element alone, transformed for all connected control units into a duplicated, safeguarded measurement signal which, without outlay in terms of the central control units, can be identified by these as a valid or implausible measurement value simply by means of the data value.

As a smallest possible unit composed of the simplest interface elements, this would be the simple coupling of two interface elements at their data interface, wherein one interface element 60 reads out a sensor and the other interface element 60′ activates an actuator. The two interface elements 60, 60′ may exchange the closed-loop control variables with one another via the data interface, and, in a closed-loop control circuit, read in the measurement values on one side of the assembly and activate actuators on the other side. By contrast to the layout shown in FIG. 4, the main control unit 24 or 48 may be omitted.

### LIST OF REFERENCE DESIGNATIONS

1 Brake system
2 Air treatment unit
4 Compressor
6 Filter cartridge
8 Casing
10 Filter cartridge line
12 Charging valve
14 Distributor unit
16 Connecting line
18 Trailer control module
20 Control valve
22 Wheel brake cylinder
24 Control unit
26 Control signal
28 Wheel rotational speed sensors
30 Wheel rotational speed sensor signal
36 Front-axle valve module
38 Footbrake module
48 EBS control unit
50 Rear-axle valve module
52 Wheel brake cylinder
60 Interface element
62 Connection
64 Pressure sensor
66 Measurement signal lines
68 Battery
70 Microcontroller
72 Line
80 Data bus
A Actuators
E Electrical lines
D Data signal lines
P Pneumatic lines
M Measurement signal lines
N Utility vehicle
S Sensor elements
60′ Interface element
62′ Connection
64′ Pressure sensor
66′ Measurement signal lines
68′ Battery
70′ Microcontroller
72′ Electrical control line

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An interface element for a utility vehicle, comprising:
electronic components, wherein the electronic components have at least one connection to at least one data interface of a vehicle, wherein
the connection is suitable and created for exchange of measurement data and/or open-loop and/or closed-loop control data for control of the electronic components,
wherein the electronic components further have at least one integrated measurement and/or open-loop control and/or closed-loop control unit.

2. The interface element as claimed in claim 1, wherein
the integrated measurement and/or open-loop control and/or closed-loop control unit comprises a microcontroller.

3. The interface element as claimed in claim 2, wherein
the integrated measurement and/or open-loop control and/or closed-loop control unit further comprises a processor, an integrated circuit and/or at least one data interface.

4. The interface element as claimed in claim 1, wherein
the interface element is in a form of a plug-in element.

5. The interface element as claimed in claim 1, wherein
the interface element is formed in a cable or as a cable element.

6. The interface element as claimed in claim 1, wherein
the electronic components are of water-tight protected form.

7. The interface element as claimed in claim 1, wherein
the interface element is connectable or connected to a sensor.

8. The interface element as claimed in claim 7, wherein
the sensor is a wheel rotational speed sensor.

9. The interface element as claimed in claim 1, wherein
the interface element is connectable or connected to an actuator.

10. The interface element as claimed in claim 1, wherein
the connection comprises a wired connection.

11. The interface element as claimed in claim 1, wherein
the connection comprises a radio connection.

12. The interface element as claimed in claim 1, wherein
the connection comprises an optical connection.

13. The interface element as claimed in claim 1, wherein
the connection comprises a magnetic connection.

14. The interface element as claimed in claim 1, wherein
the interface element is connectable or connected to an external power supply source.

15. The interface element as claimed in claim 1, wherein
the interface element is connectable or connected to an internal power supply source, wherein the internal power supply source comprises a battery.

16. The interface element as claimed in claim 1, wherein
the interface element has an interface to a fleet management system and/or to a mobile terminal.

17. The interface element as claimed in claim 1, wherein
the interface element has an encrypted communication protocol system configured such that the interface element exchanges data via the communication protocol system.

18. The interface element as claimed in claim 1, wherein
the interface element has a monitoring unit by which continuously received measurement signals are automatically monitored for monitoring an operating state of the vehicle.

19. The interface element as claimed in claim 1, wherein
the interface element has a signal comparison unit by which measurement and/or open-loop control and/or closed-loop control signals in the interface element and in the vehicle are compared and/or checked for plausibility.

20. A utility vehicle or rail vehicle, comprising at least one interface element as claimed in claim 1.

21. A method for at least one of partial measurement, open-loop control, closed-loop control, and monitoring of a utility vehicle or rail vehicle, the method comprising:
performing the at least one of partial measurement, open-loop control, closed-loop control, and monitoring of the utility vehicle not by central control units in a vehicle architecture but rather in a decentralized fashion by at least one interface element, wherein the interface element comprises:
electronic components, wherein the electronic components have at least one connection to at least one data interface of the vehicle, wherein
the connection is suitable and created for exchange of measurement data and/or open-loop and/or closed-loop control data for control of the electronic components,
wherein the electronic components further have at least one integrated measurement and/or open-loop control and/or closed-loop control unit.
